(19) United States
(12) Patent Application Publication
(10) Pub. No.: US 2026/0278260 A1
(43) Pub. Date: Sep. 17, 2026

(54) AUTOMATED VALIDATION CONTENT GENERATION CORRESPONDING TO A DEFINED VALIDATION PROTOCOL

(71) Applicant: ValGenesis, Inc., Santa Clara, CA (US)

(72) Inventors: Arun Deepak Arunagiri, Chennai (IN); Ramesh Chinnaraju, Chennai (IN); Thirukkumaran Susendran, Chennai (IN); Sivakumar Muthusamy, Fremont, CA (US)

(21) Appl. No.: 19/356,984

(22) Filed: Oct. 13, 2025

(30) Foreign Application Priority Data
Dec. 13, 2024 (IN) 202411098691

(51) Int. Cl. G06F 40/186; G06F 40/295

(52) U.S. Cl. CPC G06F 40/186; G06F 40/295

(57) ABSTRACT

Automated validation content generation corresponding to a defined validation protocol is presented herein. A system obtains a document template comprising defined validation criteria of a defined validation process. In response to a group of validation documents that have been stored in the system being determined not to correspond to the document template, the system extracts, based on respective validation document scores that have been assigned to the validation documents via a sequence matching-based large language learning model (LLM), respective extracted content from validation document(s) that have been determined to comprise at least a portion of the defined validation criteria. The system populates, via a retrieval-augmented generation (RAG)-based LLM, empty section(s) of the document template with the respective extracted content to obtain a validation document.

### RELATED APPLICATION

The subject patent application claims priority to Indian Provisional Patent Application No. 202411098691, filed Dec. 13, 2024, and entitled “AUTOMATED VALIDATION CONTENT GENERATION CORRESPONDING TO A DEFINED VALIDATION PROTOCOL”, the entirety of which priority application is hereby incorporated by reference herein.

### TECHNICAL FIELD

The subject disclosure generally relates to embodiments for automated validation content generation corresponding to a defined validation protocol.

### BACKGROUND

Life sciences companies, e.g., drug manufacturers, must validate every piece of equipment, instrument, software, process, and facility, which often results in use of thousands of validation protocols. For multi-site (e.g., multi-region and/or global) companies, generation of validation content (e.g., for validation of a manufacturing process) is inefficient, inconsistent, and/or of subpar quality due to duplicative effort and/or resources being used to manually generate validation content for a process (e.g., a manufacturing process) that is used/reused at different locations. Further, manual generation of validation protocol process(es) results in inconsistent and/or error prone validation content that negatively impacts regulatory compliance.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a validation/qualification process environment including an automated validation content generation system that facilitates automated validation content generation corresponding to a defined validation/qualification protocol for validation of a defined process for a defined entity (e.g., an equipment validation of an equipment; a system validation of a system (e.g., a computer system); a software validation of software; or a facility validation of a facility (e.g., building, manufacturing location, or similar structure), in accordance with various example embodiments;

FIG. 2 illustrates a block diagram of an automated validation content generation system that facilitates the automated validation content generation corresponding to the defined validation/qualification protocol, in accordance with various example embodiments;

FIG. 3 illustrates a block diagram representing operations that are performed via a content authoring component and an automatic content generation component (e.g., a Valgenesis® (“VAL”) “Smart Content Generator”) of the automated validation content generation system, in accordance with various example embodiments;

FIG. 4 illustrates a block diagram representing operations that are performed via the automatic content generation component in response to documents being stored in a data store (e.g., database (“db”) of the automated validation content generation system being determined not to comprise user selected information comprising an entity name of the defined entity, a document template, and a content type, in accordance with various example embodiments;

FIGS. 5-7 illustrate block diagrams of a scoring process that is performed by the automatic content generation component and that determines respective scores of the documents that have been stored in the data store representing a similarity between the documents and the user selected information corresponding to the defined validation/qualification protocol, in accordance with various example embodiments;

FIG. 8 illustrates a block diagram of further operations that are performed via the automatic content generation component in response to the documents being stored in the data store of the automated validation content generation system being determined not to comprise the user selected information corresponding to the defined validation/qualification protocol, in accordance with various example embodiments;

FIG. 9 illustrates a block diagram of operations that are performed via the automatic content generation component in response to document(s) being stored in the data store of the automated validation content generation system being determined to comprise the user selected information corresponding to the defined validation/qualification protocol, in accordance with various example embodiments;

FIG. 10 illustrates a block diagram of a validation component of the automated validation content generation system that performs validation for the defined process for the defined entity according to the defined validation/qualification protocol utilizing a validation document comprising content that has been automatically generated via the automated validation content generation system, in accordance with various example embodiments;

FIGS. 11-13 illustrate block diagrams of a process that is performed by the automated validation content generation system that facilitates automated validation content generation corresponding to the defined validation/qualification protocol for validation of the defined process for the defined entity, in accordance with various example embodiments;

FIGS. 14-15 illustrate block diagrams of another process that is performed by the automated validation content generation system that facilitates automated validation content generation corresponding to the defined validation/qualification protocol for validation of the defined process for the defined entity, in accordance with various example embodiments; and

FIG. 16 is a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Conventional validation technologies have had some drawbacks such as lacking awareness of reusable validation protocols across sites, leading to redundancy; manual creation of validation protocols that is time-consuming, inconsistent, and prone to errors; and creating validation protocols of subpar quality, e.g., including errors in grammar, structure, and presentation of protocols-impacting regulatory compliance and professional standards.

On the other hand, in various embodiments disclosed herein, an automated validation content generation system can facilitate a more efficient, consistent, and accurate validation/qualification by automatically generating validation content corresponding to a defined validation/qualification protocol of a defined validation/qualification process.

In embodiment(s), a system, e.g., an automated validation content generation system, comprises: a processing component comprising at least one processor; and a memory component comprising at least one memory that stores executable components that, when executed by the at least one processor, facilitate performance of operations by the system, the operations comprising: obtaining a document template representing a defined content type of a validation document comprising defined validation criteria for respective test steps of a defined validation process for a defined process for a defined entity name of a defined entity, wherein the document template comprises a group of empty sections corresponding to the respective test steps for the defined validation process for the defined entity. In embodiment(s), the group of empty sections corresponds to test requirements and/or test descriptions corresponding to the respective test steps, e.g., as defined and/or specified via reference document(s) (e.g., a user requirement document/specification (“URS”), a system requirement document/specification (“SRS”), or a design specification) that comprises portion(s) of the defined validation criteria for the respective test steps.

The operations further comprise: in response to a group of validation documents that have been stored in a data store of the system being determined not to correspond to the document template representing the defined content type of the validation document for the defined entity name of the defined entity, based on respective validation document scores that have been assigned—utilizing a sequence matching-based large language learning model (LLM)—to the validation documents that have been sorted according to the respective validation document scores to obtain a group of sorted scored validation documents, extracting, via the sequence matching-based LLM, respective extracted content from at least one scored validation document of the group of sorted scored validation documents that has been determined to comprise at least a portion of the defined validation criteria for the respective test steps to be populated in the group of empty sections; and populating, via a retrieval-augmented generation (RAG)-based LLM, at least one empty section of the group of empty sections of the document template with the respective extracted content comprising the portion of the defined validation criteria for the respective test steps to obtain a completed section of the validation document for the defined validation process for the defined entity.

In other embodiment(s), the document template comprises a text document and/or a Microsoft® Word document, wherein a row of a table of the text document or the Microsoft® Word document represents a test step of the respective test steps, wherein a cell of the row of the table that corresponds to a column of the table comprises the empty section of the group of empty sections of the document template, and wherein the operations further comprise: in response to determining that the document template is not written in English, translating the document template into English; and in response to determining that one or more validation documents of the group of validation documents that have been stored in the data store are not written in English, translating the one or more validation documents into English.

In embodiment(s), the operations further comprise: identifying, e.g., via a content authoring initiation component described herein, a document template associated with a selected validation type, the document template being stored in a source language; accessing, e.g., via an automatic content generation component described herein, one or more validation source documents stored in respective languages that are different from the source language; determining, e.g., via a UI, a user-specified target language for document generation; automatically translating, by an AI-based (e.g., an LLM-based) translation engine, the document template to into the user-specified target language to obtain a translated document template; automatically translating, by the AI-based translation engine, the one or more validation source documents into the user-specified target language to obtain translated source documents; extracting, e.g., via the automatic content generation component (e.g., via a sequence matching-based LLM), semantically relevant validation content (e.g., respective extracted content) from the translated source documents; and generating, via the automatic content generation component based on the translated document template and the extracted semantically relevant validation content, a validation document in the user-specified target language.

In other embodiment(s), the operations further comprise: maintaining, via the automatic content generation component using the data store, a language-agnostic representation of validation content within a unified multilingual knowledge graph; and enabling subsequent document generation in any user-specified target language without requiring translation/re-translation of corresponding content.

In yet other embodiment(s), the defined content type comprises an operational qualification of the defined entity, an installation qualification of the defined entity, a performance qualification of the defined entity, or a design qualification of the defined entity.

In embodiment(s), the defined entity comprises an equipment that is used during the test step of the respective test steps, an instrument that is used during the test step, a computer system that is used during the test step, software that is used during the test step, or a facility that is used during the test step.

In other embodiment(s), the operations further comprise: in response to the respective test steps being executed via the defined entity during an execution of the defined validation process, validating, based on the defined validation criteria for the respective test steps represented by the validation document, the execution of the defined validation process.

In yet other embodiment(s), the extracting of the respective extracted content from the scored validation document further comprises: assigning, via the sequence matching-based LLM, the respective validation document scores to the validation documents to obtain scored validation documents; sorting the scored validation documents in a descending order of the respective validation document scores to obtain the group of sorted scored validation documents; and based on the descending order of the respective validation document scores, extracting, via the sequence matching-based LLM, the respective extracted content from the group of sorted scored validation documents.

In embodiment(s), the assigning of the respective validation document scores to the validation documents further comprises: determining, via the sequence matching-based LLM, respective entity name scores representing respective amounts of similarity between the defined entity name and respective entity names corresponding to the validation documents, respective content type scores representing respective amounts of similarity between the defined content type and respective content types of the validation documents, respective section scores representing respective numbers of section names of the group of empty sections of the document template that correspond to respective groups of sections of the validation documents, and respective sums of the respective entity name scores, the respective content type scores, and the respective section scores; and assigning, as the respective validation document scores, the respective sums of the respective entity name scores, the respective content type scores, and the respective section scores to the validation documents to obtain the group of sorted scored validation documents.

In other embodiment(s), the extracting of the respective extracted content from the scored validation document further comprises: based on the descending order of the respective validation document scores, iteratively selecting the scored validation document from the group of sorted scored validation documents, determining, via the sequence matching-based LLM, whether the scored validation document comprises the portion of the defined validation criteria for the respective test steps, and in response to determining that the scored validation document comprises the portion of the defined validation criteria for the respective test steps, extracting, via the sequence matching-based LLM, the portion of the defined validation criteria for the respective test steps from the scored validation document to facilitate the empty section of the document template being populated, via the RAG-based LLM, with the portion of the defined validation criteria for the respective test steps to obtain the completed section.

In yet other embodiment(s), the scored validation document is a first scored validation document corresponding to a first descending order of the descending order of the respective validation scores, and the operations further comprise: in response to determining that the first scored validation document does not comprise the portion of the defined validation criteria for the respective test steps, and based on the descending order of the respective validation document scores, iteratively selecting a second scored validation document from the group of sorted scored validation documents corresponding to a second descending order of the descending order of the respective validation scores that directly proceeds the first descending order, determining, via the sequence matching-based LLM, whether the second scored validation document comprises the portion of the defined validation criteria for the respective test steps, and in response to determining that the second scored validation document comprises the portion of the defined validation criteria for the respective test steps, extracting, via the sequence matching-based LLM, the portion of the defined validation criteria for the respective test steps from the second scored validation document to facilitate the empty section of the document template being populated, via the RAG-based LLM, with the portion of the defined validation criteria for the respective test steps to obtain the completed section.

In embodiment(s), the operations further comprise: in response to determining that the group of sorted scored validation documents does not comprise the portion of the defined validation criteria for the respective test steps, and further in response to determining that a reference document has been associated with the document template, determining, via the sequence matching-based LLM, whether the reference document comprises the portion of the defined validation criteria for the respective test steps, and in response to determining that the reference document comprises the portion of the defined validation criteria for the respective test steps, extracting, via the sequence matching-based LLM, the portion of the defined validation criteria for the respective test steps from the reference document to facilitate the empty section of the document template being populated, via the RAG-based LLM, with the portion of the defined validation criteria for the respective test steps to obtain the completed section.

In other embodiment(s), the operations further comprise: in response to determining that a reference document has been associated with the document template, determining, via the sequence matching-based LLM, whether the reference document comprises the portion of the defined validation criteria for the respective test steps, and in response to determining that the reference document comprises the portion of the defined validation criteria for the respective test steps, extracting, via the sequence matching-based LLM, the portion of the defined validation criteria for the respective test steps from the reference document to facilitate the completed section of the document template being populated, via the RAG-based LLM, with the portion of the defined validation criteria for the respective test steps.

In yet other embodiment(s), the operations further comprise: in response to the group of validation documents that have been stored in the data store of the system being determined to correspond to the document template representing the defined content type of the validation document for the defined entity name of the defined entity, sorting the group of validation documents in descending chronological order of respective times and dates that the validation documents have been approved according to respective defined validation processes to obtain a group of chronologically sorted validation documents, and based on the descending chronological order, extracting, via the sequence matching-based LLM, respective content from the group of chronologically sorted validation documents to facilitate the empty section of the document template being populated, via the RAG-based LLM, with the portion of the defined validation criteria for the respective test steps to obtain the completed section.

In embodiment(s), the portion of the defined validation criteria for the respective test steps is a first portion of defined validation criteria, and the extracting of the respective content from the group of chronologically sorted validation documents comprises: based on the descending chronological order, iteratively selecting a sorted validation document from the group of chronologically sorted validation documents, determining whether the sorted validation document comprises a second portion of the defined validation criteria for the respective test steps, and in response to determining that the sorted validation document comprises the second portion of the defined validation criteria for the respective test steps, extracting, via the sequence matching-based LLM, the second portion of the defined validation criteria for the respective test steps from the sorted validation document to facilitate the empty section of the document template being populated, via the RAG-based LLM, with the second portion of the defined validation criteria for the respective test steps to obtain the completed section.

In other embodiment(s), the sorted validation document is a first sorted validation document corresponding to a first chronological order of the chronological order, and the operations further comprise: in response to determining that the first sorted validation document does not comprises the portion of the respective content, iteratively selecting a second sorted validation document from the group of chronologically sorted validation documents that corresponds to a second chronological order of the chronological order that directly precedes the first chronological order, determining whether the second sorted validation document comprises the portion of the respective content, and in response to determining that the second sorted validation document comprises the portion of the respective content, extracting, via the sequence matching-based LLM, the portion of the respective content from the second sorted validation document to facilitate the empty section of the document template being populated, via the RAG-based LLM, with the portion of the defined validation criteria for the respective test steps to obtain the completed section.

In yet other embodiment(s), the operations further comprise: in response to determining that the portion of the respective portions of the respective content cannot be extracted from the group of chronologically sorted validation documents, and further in response to determining that a reference document has been associated with the document template, determining, via the sequence matching-based LLM, whether the reference document comprises the portion of the defined validation criteria for the respective test steps, and in response to determining that the reference document comprises the portion of the defined validation criteria for the respective test steps, extracting, via the sequence matching-based LLM, the portion of the respective content from the reference document to facilitate the empty section of the document template being populated, via the RAG-based LLM, with the portion of the defined validation criteria for the respective test steps to obtain the completed section.

In embodiment(s), a method comprises: in response to obtaining a document template representing a defined content type of a validation document that comprises defined validation criteria for respective test steps of a defined validation process for a defined process for a defined entity name of a defined entity, determining, by a system comprising at least one processor, whether a group of validation documents that have been stored in a data store of the system corresponds to the document template representing the defined content type of the validation document for the defined entity name of the defined entity; and in response to the group of validation documents being determined not to correspond to the defined document template representing the defined content type of the validation document for the defined entity name of the defined entity, assigning, by the system using a sequence matching-based LLM, respective validation document scores to the validation documents representing respective degrees of similarity between the document template and the validation documents to obtained scored validation documents, sorting, by the system according to the respective validation document scores, the scored validation documents to obtain a group of sorted scored validation documents, and based on the respective validation document scores, determining, by the system using the sequence matching-based large LLM, whether the group of sorted scored validation documents comprises respective content comprising at least a portion of the defined validation criteria for the respective test steps of the defined validation process for the defined entity name of the defined entity.

The method further comprises: in response to the group of sorted scored validation documents being determined to comprise the respective content comprising the portion of the defined validation criteria for the respective test steps of the defined validation process for the defined entity name of the defined entity, extracting, by the system based on the respective validation document scores using the sequence matching-based LLM, the respective content from the group of sorted scored validation documents, and populating, by the system using a RAG-based LLM, respective vacant sections of the document template corresponding to the test steps with the respective content comprising the portion of the defined validation criteria for the respective test steps of the defined validation process for the defined entity name of the defined entity to obtain the validation document.

In other embodiment(s), the method further comprises: in response to the group of validation documents being determined to correspond to the defined document template representing the defined content type of the validation document for the defined entity name of the defined entity, sorting, by the system, the group of validation documents in chronological order based on respective times and dates that the validation documents have been approved according to respective validation protocols to obtain sorted validation documents, extracting, by the system based on the chronological order using the sequence matching-based LLM, the respective content from the sorted validation documents, and populating, by the system using the RAG-based LLM, the respective vacant sections of the document template corresponding to the test steps with the respective content comprising the portion of the defined validation criteria for the respective test steps of the defined validation process for the defined entity name of the defined entity to obtain the validation document.

In yet other embodiment(s), the assigning of the respective validation document scores further comprises: deriving, via the sequence matching-based LLM, respective entity name scores representing first respective amounts of similarity between the defined entity name and respective entity names corresponding to the validation documents; deriving, via the sequence matching-based LLM, respective content type scores representing second respective amounts of similarity between the defined content type and respective content types of the validation documents; deriving, via the sequence matching-based LLM, respective section scores representing respective numbers of section names of the group of sections of the document template that correspond to respective groups of sections of the validation documents; and based on respective sums of the respective entity name scores, the respective content type scores, and the respective section scores, generating the respective validation document scores, and assigning the respective validation document scores to the validation documents.

In embodiment(s), a non-transitory machine-readable medium comprises executable instructions that, when executed by at least one processor of a system, facilitate performance of operations, comprising: obtaining a document template corresponding to a defined content type representing a type of a validation document, wherein the document template comprises empty sections corresponding to respective test steps of a defined validation process for a defined process for a defined entity name of a defined entity, and wherein respective content that is populated in the empty sections of the document template is utilized during an execution of the respective test steps of the defined validation process; determining whether validation documents that have been stored in a data store of the system correspond to the document template corresponding to the defined content type representing the type of the validation document and the defined validation process for the defined entity name of the defined entity; and in response to determining that the validation documents do not correspond to the document template corresponding to the defined content type representing the type of the validation document and the defined validation process for the defined entity name of the defined entity, extracting, via a sequence matching-based LLM based on respective validation document scores that have been assigned to the validation documents, portions of the respective content from the validation documents to obtain respective extracted content comprising attributes of the respective test steps, and populating, via a RAG-based LLM, the empty sections of the document template with the respective extracted content comprising the attributes of the respective test steps to obtain the validation document.

In other embodiment(s), the operations further comprise: in response to determining that the validation documents correspond to the document template corresponding to the defined content type representing the type of the validation document and the defined validation process for the defined entity name of the defined entity, sorting the validation documents in chronological order based on respective times and dates that the validation documents have been approved according to respective validation protocols to obtain sorted validation documents, extracting, via the sequence matching-based LLM based on the chronological order, second portions of the respective content from the sorted validation documents to obtain the respected extracted content comprising the attributes of the respective test steps, and populating, via the RAG-based LLM, the empty sections of the document template with the respective extracted content comprising the attributes of the respective test steps to obtain the validation document.

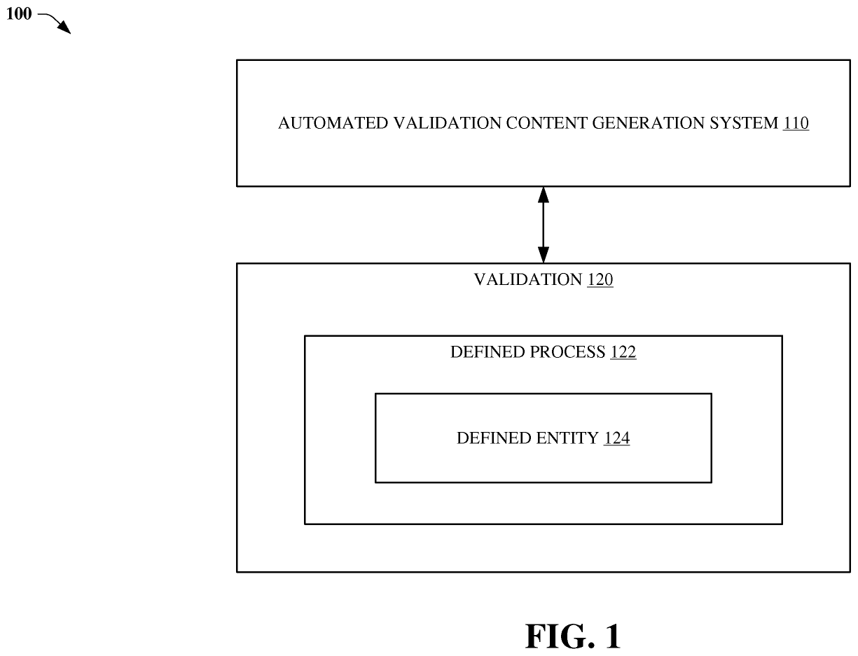

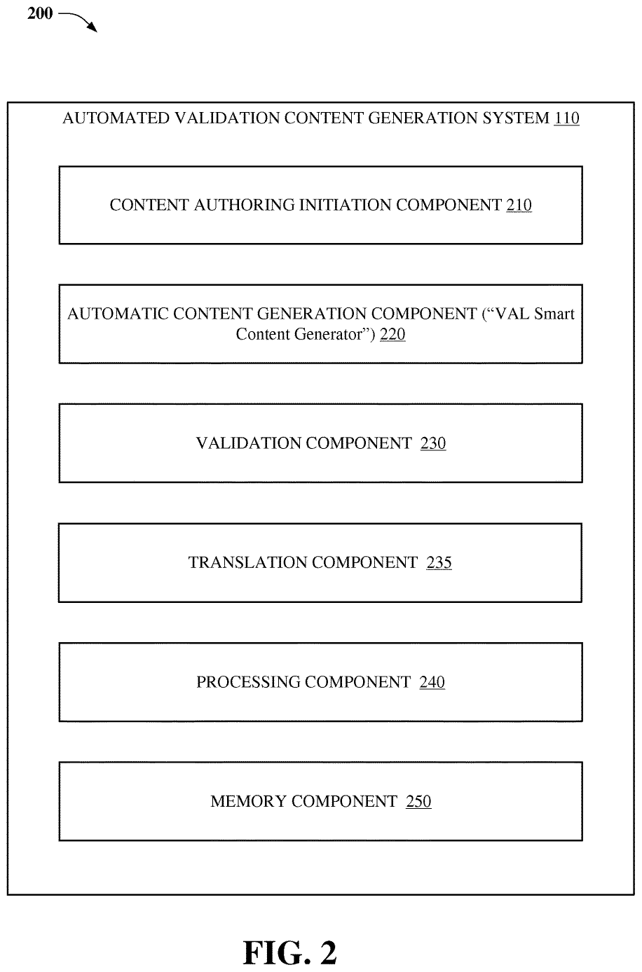

Now referring to FIGS. 1-2, block diagrams (100, 200) of a validation/qualification process environment including an automated validation content generation system (110) that facilitates automated validation content generation corresponding to a defined validation/qualification protocol for validation (120) of a defined process (122) for a defined entity (124), e.g., an equipment validation of an equipment; a system validation of a system (e.g., a computer system); a software validation of software; or a facility validation of a facility (e.g., a building, a manufacturing location, or a structure); and the automated validation content generation system are illustrated, respectively, in accordance with various example embodiments.

The automated validation content generation system includes a content authoring initiation component (210), an automatic content generation component (e.g., Valengesis® (“VAL”) “Smart Content Generator”) (220), a validation component (230), a translation component (235), a processing component (240), and a memory component (250). In embodiment(s), the memory component stores executable instructions that, when executed by the processing component, facilitate performance of operations by the automated validation content generation system.

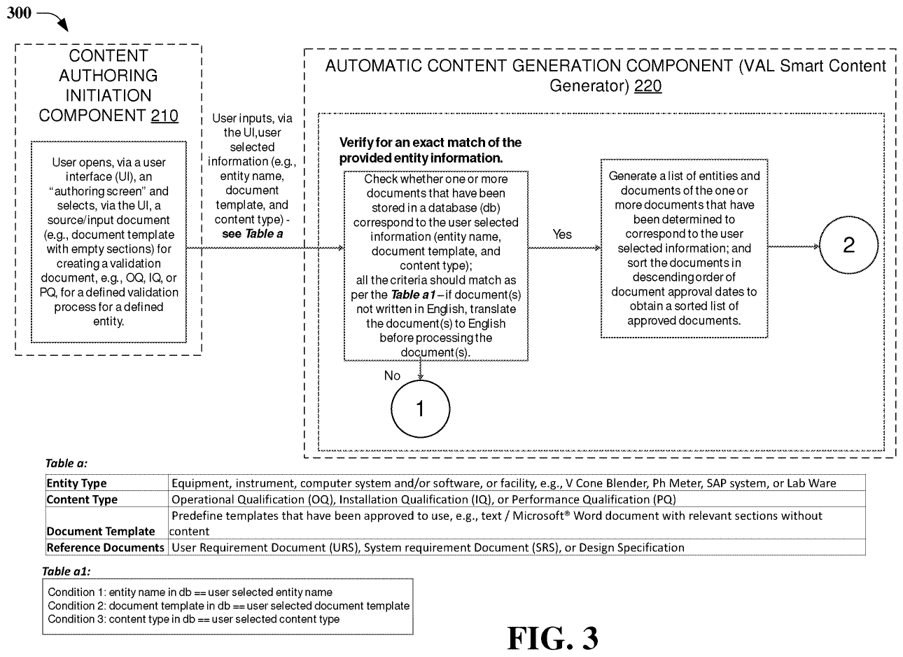

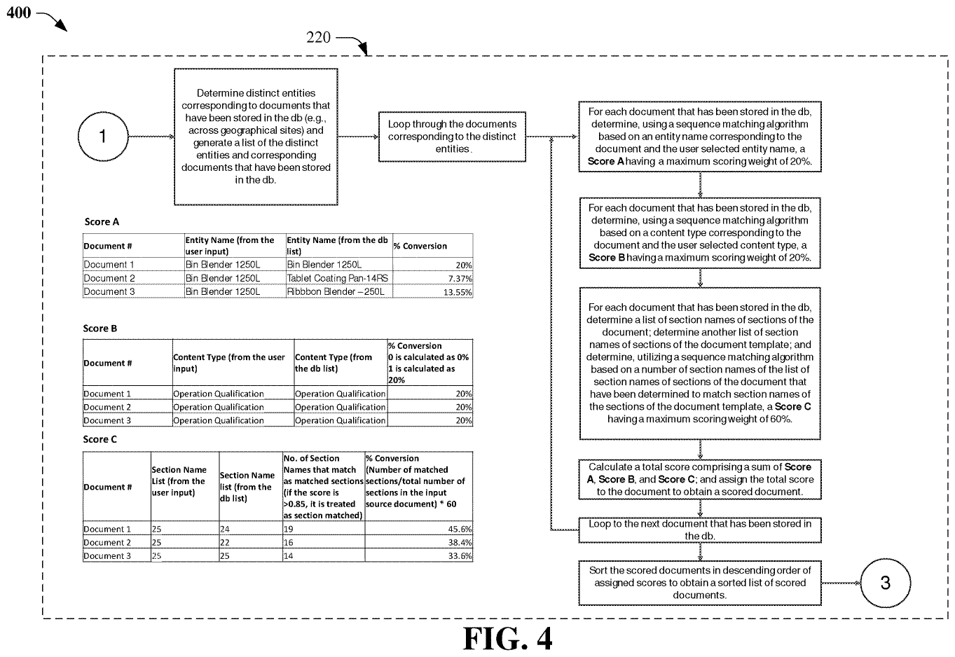

Referring now to FIGS. 3 and 4, block diagrams (300, 400) representing operations that are performed via the content authoring component and the automatic content generation component, and that are performed via the automatic content generation component in response to documents being stored in a data store (e.g., within the memory component) of the automated validation content generation system being determined not to comprise user selected information are illustrated, respectively, in accordance with various example embodiments.

The content authoring component comprises a user interface (“UI”) (not shown) that enables a user of the automated validation content generation system to select/input, e.g., via an authoring screen (not shown), a source/input document (e.g., document template with empty sections) for creating a validation document (e.g., an operational qualification (“OQ”), an installation qualification (“IQ”), a performance qualification (“PQ”), or any type of validation document).

Further, the content authoring component enables the user to input/select, via the UI, the user selected information comprising an entity name (e.g., a defined entity name, an entity type) of a defined entity. The document template represents a defined content type (e.g., OQ, IQ, PQ, or other content type) of a validation document comprising defined validation criteria for respective test steps of a defined validation process for a defined process for the defined entity name

In embodiment(s), the defined entity comprises an equipment that is used during the test step of the respective test steps, an instrument that is used during the test step, a computer system that is used during the test step, software that is used during the test step, or a facility that is used during the test step.

In other embodiment(s), the document template comprises a group of empty sections corresponding to the respective test steps for the defined validation process for the defined entity. In various embodiment(s), the document template comprises a text document and/or a Microsoft® Word document, in which a row of a table of the text document or the Microsoft® Word document represents a test step of the respective test steps, in which a cell of the row of the table that corresponds to a column of the table comprises the empty section of the group of empty sections of the document template.

In embodiment(s), the translation component can determine, e.g., via an LLM, whether the document template is written in English; and in response to determining that the document template is not written in English, the translation component can translate the document template into English.

In yet other embodiment(s), the content authoring component enables the user to input/select, via the UI, a reference document (e.g., URS, SRS, or design specification) that comprises portion(s) of the defined validation criteria for the respective test steps.

In turn, the automatic content generation component determines/checks whether one or more documents that have been stored in the data store correspond to the user selected information (e.g., entity name, document template, and content type). (See, e.g., Table a, Table 1a).

In embodiment(s), the translation component can determine whether document(s), e.g., validation document(s), of the one or more documents have been written in English; and in response to determining that the document(s) are not written in English, the translation component translates the document(s) into English, e.g., for processing described herein to be performed by the automatic content generation component, e.g., for scoring of the documents.

As illustrated by FIG. 4, in response to determining that no documents that have been stored in the data store correspond to the document template representing the defined content type of the validation document for the defined entity name of the defined entity, the automatic content generation component determines distinct entities corresponding to documents that have been stored in the data store, and/or in respective data stores (not shown) that are located at/across different geographical sites/locations, and generates a list of the distinct entities and corresponding documents that have been stored in the data store.

Further, the automatic content generation component loops through the documents corresponding to the distinct entities and performs the following for each document that has been stored in the data store: (1) determine, using a sequence matching, e.g., LLM-based, algorithm based on an entity name corresponding to the document and the user selected entity name/defined entity name, an entity name score representing an amount of similarity between the defined entity name and the entity name corresponding to the document, e.g., a “Score A” having a maximum scoring weight of 20%; (2) determine, using the sequence matching algorithm based on a content type corresponding to the document and the user selected content type/defined content type, a content type score representing an amount of similarity between the defined content type and the content type corresponding to the document, e.g., a “Score B” having a maximum scoring weight of 20%; (3) determine a list of section names of sections of the document; determine another list of section names of sections/empty sections of the document template; and determine, utilizing the sequence matching algorithm based on a number of section names of the list of section names of sections of the document that have been determined to match section names of the empty sections of the document template, a section score representing the number of section names of the empty sections of the document template that correspond to/match section names of the sections of the document, e.g., a “Score C” having a maximum scoring weight of 60%.

In turn, the automatic content generation component calculates a total score comprising a sum of Score A, Score B, and Score C; and assigns the total score to the document to obtain a scored document.

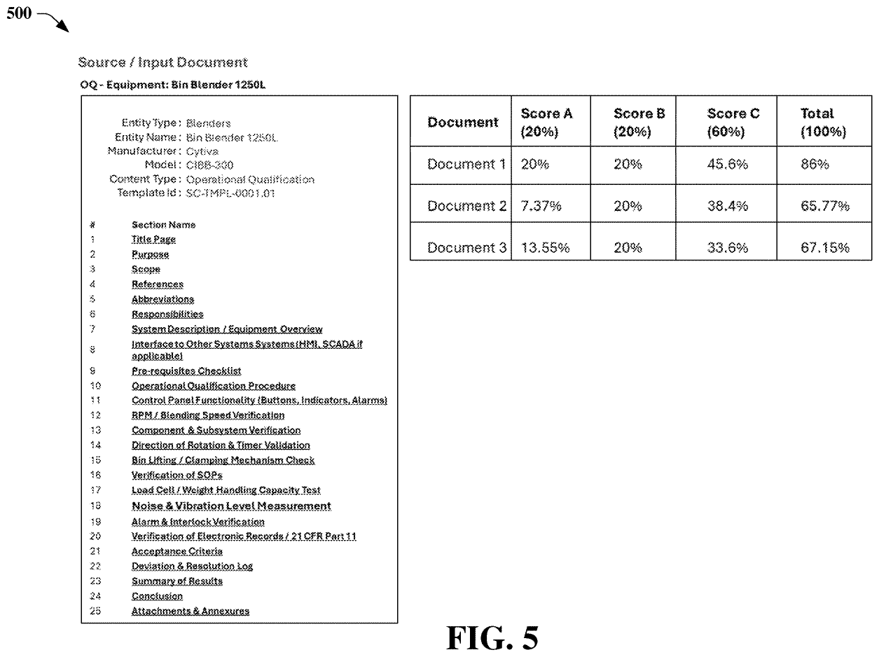

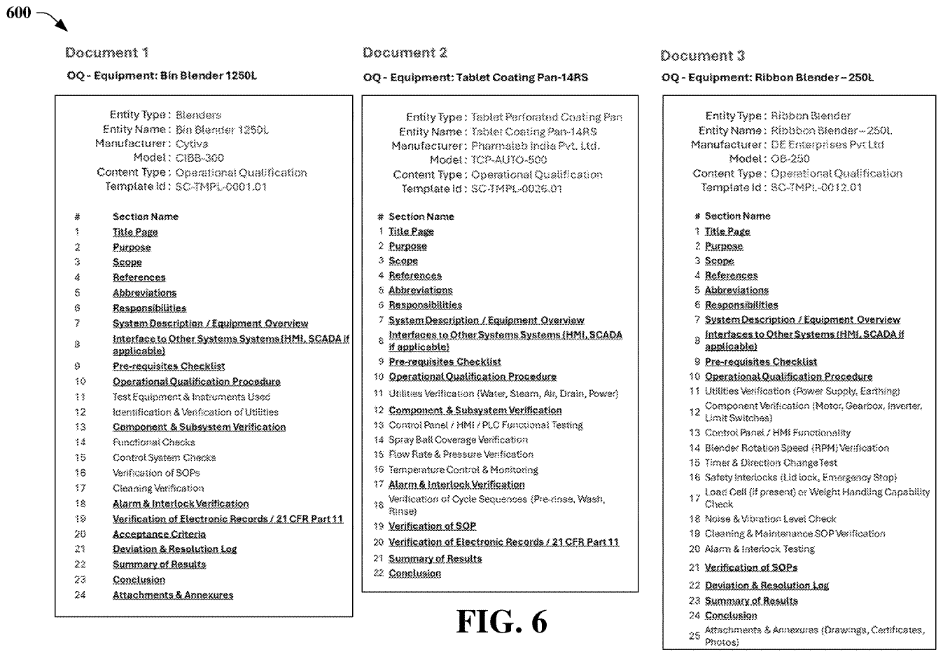

FIGS. 5-7 illustrate block diagrams (500, 600, 700) of a scoring process that is performed by the automatic content generation component to generate/determine respective scores of documents (e.g., “Document 1”, “Document 2”, and “Document 3”) that have been stored in the data store—the respective scores representing a similarity between the documents and the user selected information corresponding to a document template (e.g., “Source/Input Document”, or OQ for an entity name/defined entity name “Bin Blender 1250” of an entity type “Blenders” and content type “OQ”) and the defined validation/qualification protocol, in accordance with various example embodiments.

As illustrated by FIG. 5, the sequence matching-based LLM (1) derived respective entity name scores (Score A) representing first respective amounts of similarity (“20%”, “7.37%”, “13.55%”) between the defined entity name and respective entity names corresponding to the documents (e.g., Document 1, Document 2, and Document 3); (2) derived respective content type scores (Score B) representing second respective amounts of similarity (“20%”, “20%”, “20%”) between the defined content type and respective content types corresponding to the documents; (3) derived respective section scores (Score C) representing respective numbers of section names of respective sections of the documents that have been determined to match section names of the empty sections of the document template (“45.6%”, “38.4%”, “33.6%”); and (4) derived respective sums (“86%”, “65.77%”, “67.15%”) of the respective entity name scores, the respective content type scores, and the respective section scores.

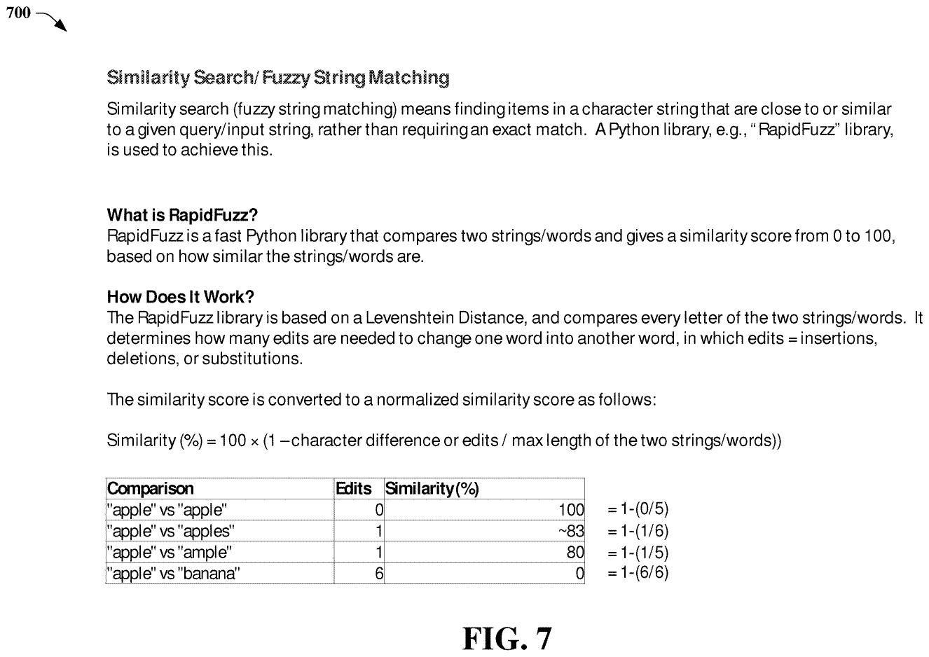

As illustrated by FIG. 7, the sequence matching-based LLM utilizes a similarity search, e.g., fuzzy string matching, to find items in a character string that are close to, or similar to, a given query/input string, rather than requiring an exact match. In embodiment(s), a Python library, e.g., “RapidFuzz” library, is used to perform the similarity search by comparing two strings/words, and determining a similarity between the two strings/words.

In embodiment(s), the RapidFuzz library is based on a Levenshtein, or edit distance, and compares every letter of the two strings/words. It determines how many edits are needed to change/transform one word into another word, in which edits=insertions, deletions, or substitutions.

Further, the sequence matching-based LLM converts the similarity score to a normalized similarity score as follows: similarity (%)=100×(1−character difference or edits/max length of the two strings/words)); assigns respective normalized scores to the document to obtain respective scored documents; and sorts the scored documents in descending order of assigned scores to obtain a sorted list of scored documents.

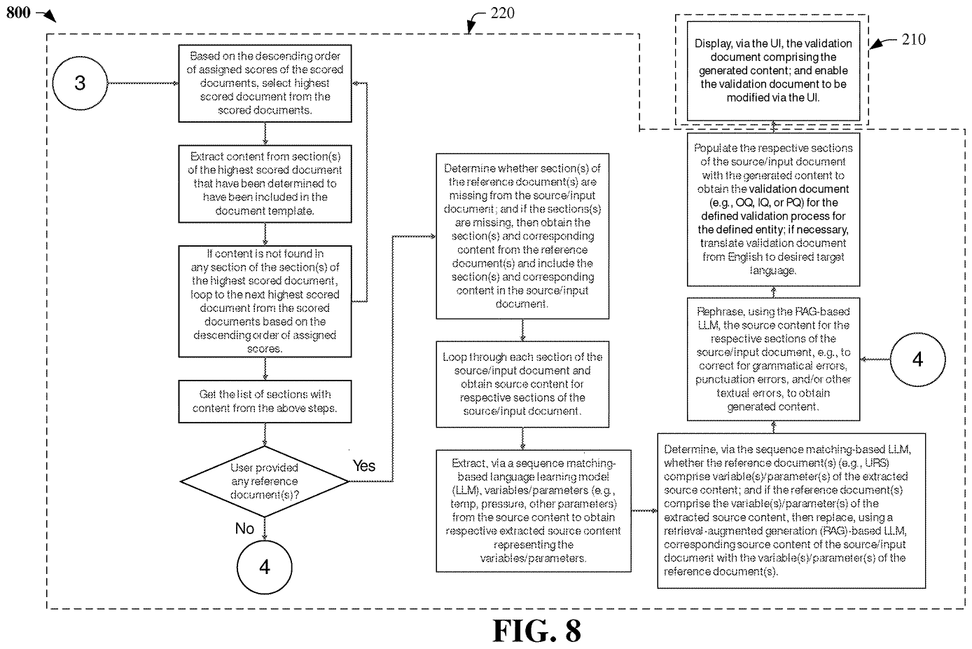

Referring now to FIG. 8, a block diagram (800) representing operations that are performed via the automatic content generation component in response to the documents being stored in the data store of the automated validation content generation system being determined not to comprise the user selected information corresponding to the defined validation/qualification protocol, in accordance with various example embodiments.

Based on the descending order of assigned scores of the scored documents, the automatic content generation component: selects a highest scored document from the scored documents; and extracts content from section(s) of the highest scored document that have been determined to have been included in the document template.

In response to determining that content cannot be found in any section of the section(s) of the highest scored document, the automatic content generation component loops to the next highest scored document from the scored documents based on the descending order of assigned scores.

After generating a list of sections and corresponding content that has been extracted from the section(s), the automatic content generation component determines whether the user has provided, via the UI, any reference documents; and in response to determining that the user has provided reference document(s), the automatic content generation component: determines whether section(s) of the reference document(s) are missing from the source/input document; and in response to determining that the sections(s) are missing, the automatic content generation component obtains the section(s) and corresponding content from the reference document(s) and includes the section(s) and corresponding content in the source/input document.

The automatic content generation component further: loops through each section of the source/input document/document template and obtains source content for respective sections of the source/input document/document template; and extracts, via the sequence matching-based LLM, variables/parameters (e.g., temp, pressure, other parameters) from the source content to obtain respective extracted source content representing the variables/parameters.

In turn, the automatic content generation component: determines, via the sequence matching-based LLM, whether the reference document(s) comprise variable(s)/parameter(s) of the extracted source content; and in response to determining that the reference document(s) comprise the variable(s)/parameter(s) of the extracted source content, the automatic content generation component replaces, using a RAG-based LLM, corresponding source content of the source/input document/document template with the variable(s)/parameter(s) of the reference document(s).

Further, the automatic content generation component populates the respective sections of the source/input document/document template with the generated content to obtain the validation document (e.g., OQ, IQ, or PQ) for the defined validation process; translates the validation document from English to a desired target language, e.g., as selected/specified via the UI; displays, via the UI, the validation document comprising the generated content; and enables the validation document to be modified via the UI.

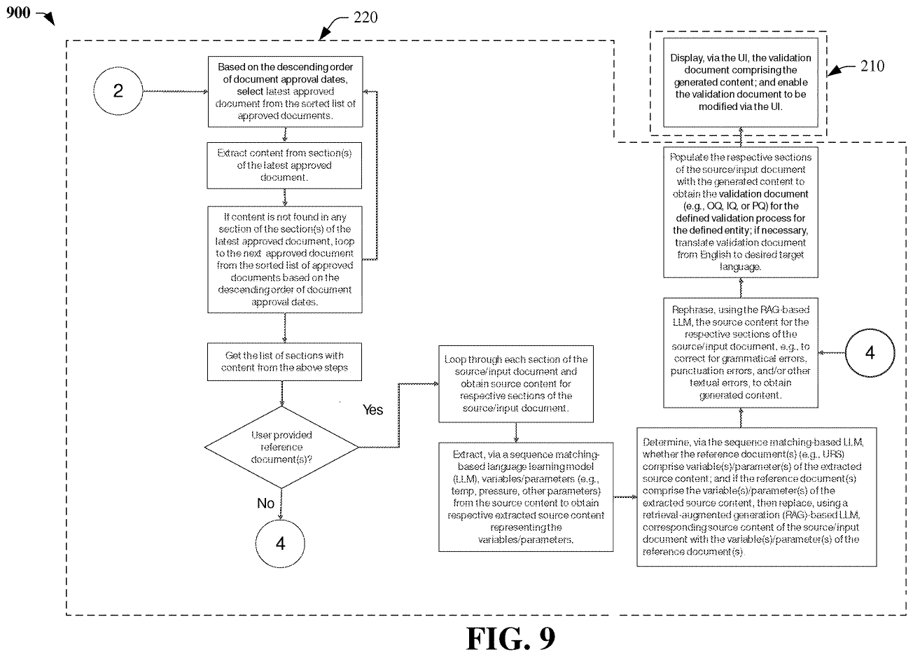

Referring now to FIGS. 3 and 9, in response to document(s) being stored in the data store of the automated validation content generation system being determined to comprise the user selected information corresponding to the defined validation/qualification protocol, the automatic content generation component generates a list of entities and document(s) that have been determined to correspond to the user selected information; and sorts the documents in descending order of document approval dates to obtain a sorted list of approved documents.

Based on the descending order of document approval dates, the automatic content generation component selects the latest approved document from the sorted list of approved documents and extracts content from section(s) of the latest approved document.

In response to content being determined not to be found in any section of the latest approved document, the automated validation content generation system loops to the next approved document from the sorted list of approved documents based on the descending order of document approval dates.

After generating a list of sections and corresponding content that has been extracted from the sorted list of approved documents, the automatic content generation component loops through each section of the source/input document/document template and obtains source content for respective sections of the source/input document/document template; and extracts, via the sequence matching-based LLM, variables/parameters (e.g., temp, pressure, other parameters) from the source content to obtain respective extracted source content representing the variables/parameters.

Further, the automatic content generation component: determines, via the sequence matching-based LLM, whether the reference document(s) comprise variable(s)/parameter(s) of the extracted source content; and in response to determining that the reference document(s) comprise the variable(s)/parameter(s) of the extracted source content, the automatic content generation component replaces, using a RAG-based LLM, corresponding source content of the source/input document/document template with the variable(s)/parameter(s) of the reference document(s).

In turn, the automatic content generation component populates the respective sections of the source/input document/document template with the generated content to obtain the validation document (e.g., OQ, IQ, or PQ) for the defined validation process; translates the validation document from English to a desired target language, e.g., as selected/specified via the UI; displays, via the UI, the validation document comprising the generated content; and enables the validation document to be modified via the UI.

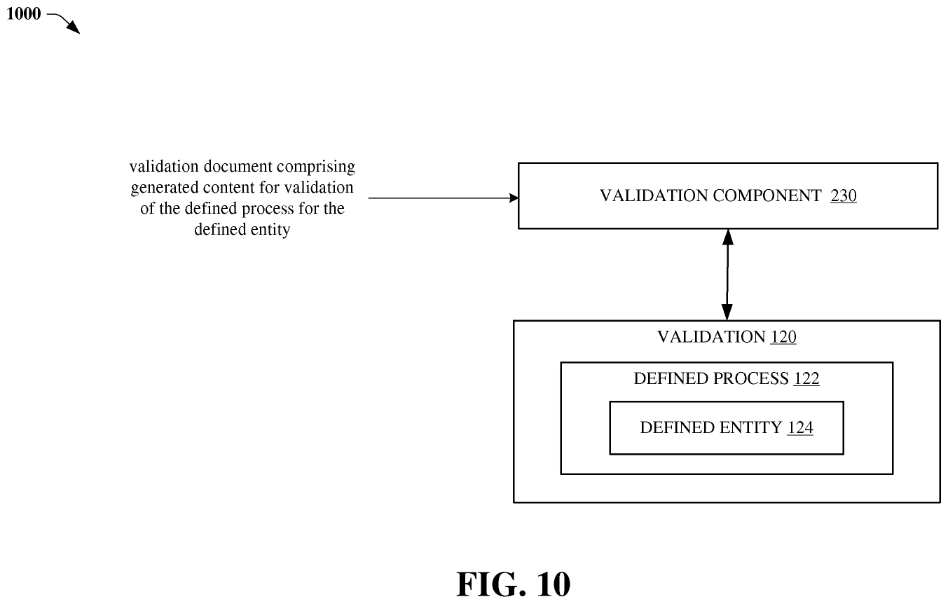

FIG. 10 illustrates a block diagram (1000) of a validation component (230) of the automated validation content generation system that performs validation (120) for a defined process (122) for a defined entity (124) (e.g., an equipment validation of an equipment; a system validation of a system (e.g., a computer system); a software validation of software; or a facility validation of a facility (e.g., building, manufacturing location, or similar structure) according to a defined validation/qualification protocol utilizing the validation document comprising content that has been automatically generated via the automatic content generation component, in accordance with various example embodiments.

In response to respective test steps of the defined process being executed via the defined entity, e.g., during an execution of the defined validation process, the validation component, e.g., in response to receiving, via the UI, an input directing the automated validation content generation system to perform the validation for the defined process using the validation document, validates, based on the defined validation criteria for the respective test steps represented by the validation document, the execution of the defined validation process, e.g., of the defined process.

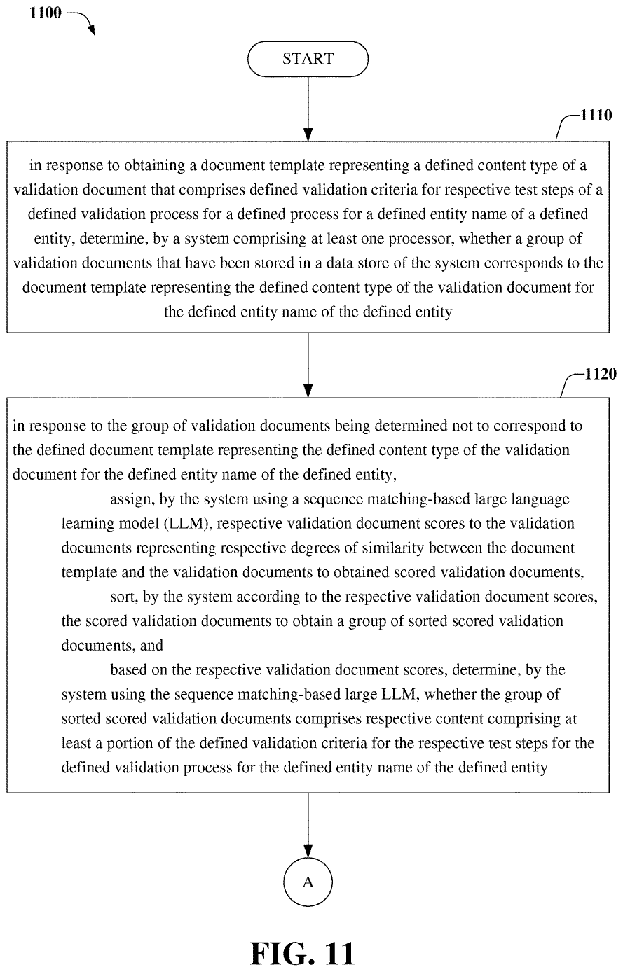

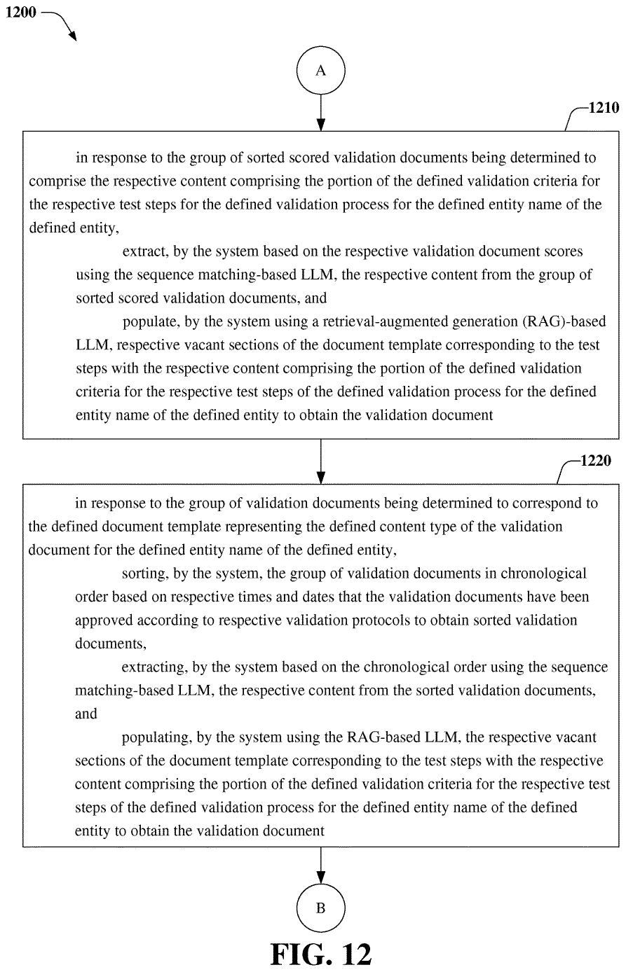

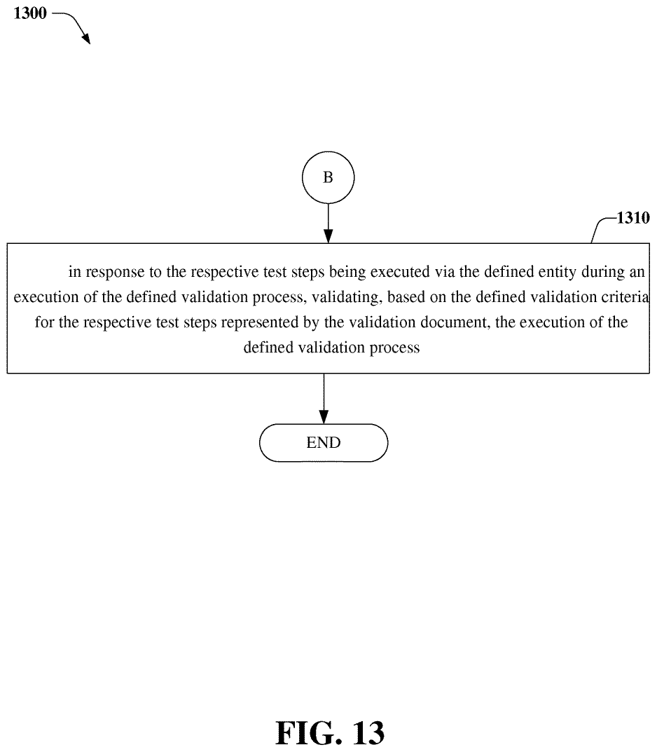

FIGS. 11-15 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIGS. 11-13 illustrate block diagrams (1100-1300) of a process that is performed by the automated validation content generation system that facilitates automated validation content generation corresponding to the defined validation/qualification protocol for validation of the defined process for the defined entity (e.g., an equipment validation of an equipment; a system validation of a system (e.g., a computer system); a software validation of software; or a facility validation of a facility (e.g., building, manufacturing location, or similar structure), in accordance with various example embodiments.

At 1110, in response to obtaining a document template representing a defined content type of a validation document that comprises defined validation criteria for respective test steps of a defined validation process for a defined process for a defined entity name of a defined entity, the automated validation content generation system determines whether a group of validation documents that have been stored in a data store of the system corresponds to the document template representing the defined content type of the validation document for the defined entity name of the defined entity.

At 1120, in response to the group of validation documents being determined not to correspond to the defined document template representing the defined content type of the validation document for the defined entity name of the defined entity, the automated validation content generation system: assigns, using a sequence matching-based LLM, respective validation document scores to the validation documents representing respective degrees of similarity between the document template and the validation documents to obtained scored validation documents; sorts, according to the respective validation document scores, the scored validation documents to obtain a group of sorted scored validation documents; and based on the respective validation document scores, determines, using the sequence matching-based large LLM, whether the group of sorted scored validation documents comprises respective content comprising at least a portion of the defined validation criteria for the respective test steps for the defined validation process for the defined entity name of the defined entity.

At 1210, in response to the group of sorted scored validation documents being determined to comprise the respective content comprising the portion of the defined validation criteria for the respective test steps for the defined validation process for the defined entity name of the defined entity, the automated validation content generation system: extracts, based on the respective validation document scores using the sequence matching-based LLM, the respective content from the group of sorted scored validation documents; and populates, using a RAG-based LLM, respective vacant sections of the document template corresponding to the test steps with the respective content comprising the portion of the defined validation criteria for the respective test steps of the defined validation process for the defined entity name of the defined entity to obtain the validation document.

At 1220, in response to the group of validation documents being determined to correspond to the defined document template representing the defined content type of the validation document for the defined entity name of the defined entity, the automated validation content generation system: sorts the group of validation documents in chronological order based on respective times and dates that the validation documents have been approved according to respective validation protocols to obtain sorted validation documents; extracts, based on the chronological order using the sequence matching-based LLM, the respective content from the sorted validation documents; and populates, using the RAG-based LLM, the respective vacant sections of the document template corresponding to the test steps with the respective content comprising the portion of the defined validation criteria for the respective test steps of the defined validation process for the defined entity name of the defined entity to obtain the validation document.

At 1310, in response to the respective test steps being executed via the defined entity during an execution of the defined validation process, the automated validation content generation system validates, based on the defined validation criteria for the respective test steps represented by the validation document, the execution of the defined validation process.

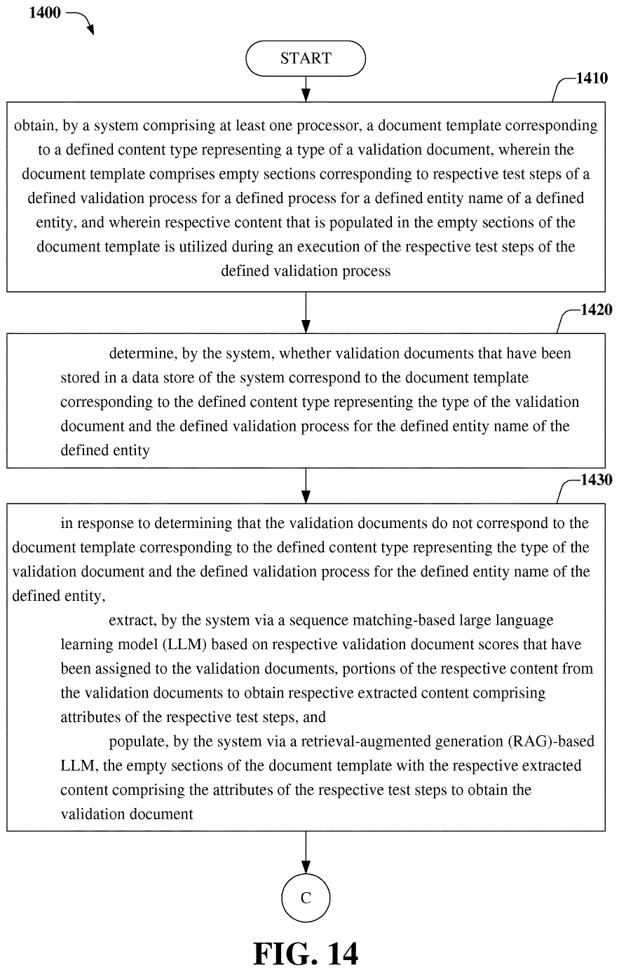

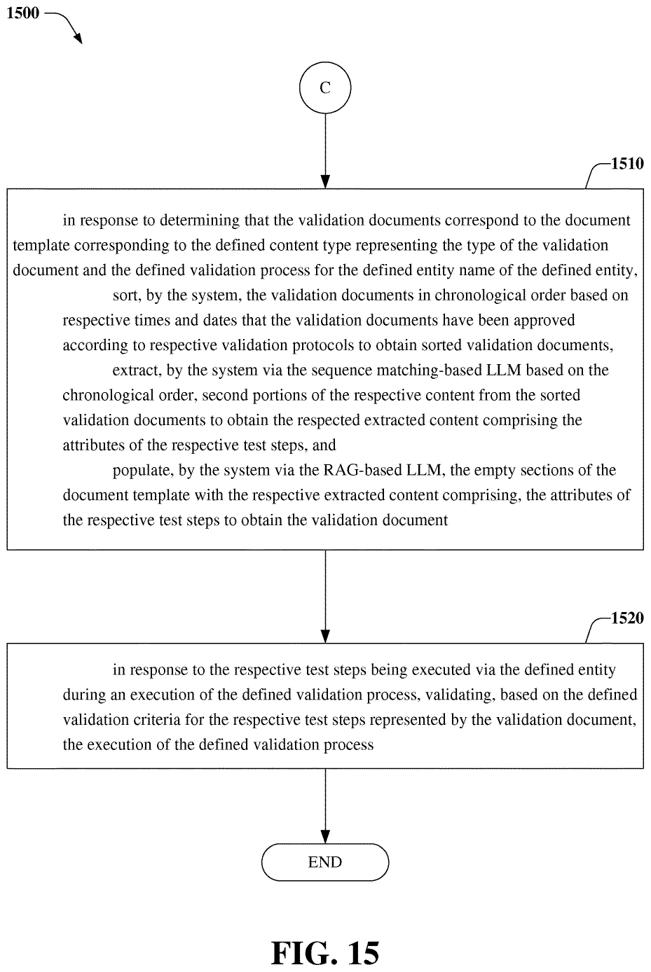

FIGS. 14-15 illustrate block diagrams (1400-1500) of another process that is performed by the automated validation content generation system that facilitates automated validation content generation corresponding to the defined validation/qualification protocol for validation of the defined process for the defined entity, in accordance with various example embodiments.

At 1410, the automated validation content generation system obtains a document template corresponding to a defined content type representing a type of a validation document, wherein the document template comprises empty sections corresponding to respective test steps of a defined validation process for a defined process for a defined entity name of a defined entity, and wherein respective content that is populated in the empty sections of the document template is utilized during an execution of the respective test steps of the defined validation process.

At 1420, the automated validation content generation system determines whether validation documents that have been stored in a data store of the system correspond to the document template corresponding to the defined content type representing the type of the validation document and the defined validation process for the defined entity name of the defined entity.

At 1430, in response to determining that the validation documents do not correspond to the document template corresponding to the defined content type representing the type of the validation document and the defined validation process for the defined entity name of the defined entity, the automated validation content generation system: extracts, via a sequence matching-based LLM based on respective validation document scores that have been assigned to the validation documents, portions of the respective content from the validation documents to obtain respective extracted content comprising attributes of the respective test steps; and populates, via a RAG-based LLM, the empty sections of the document template with the respective extracted content comprising the attributes of the respective test steps to obtain the validation document.

At 1510, in response to determining that the validation documents correspond to the document template corresponding to the defined content type representing the type of the validation document and the defined validation process for the defined entity name of the defined entity, the automated validation content generation system: sorts the validation documents in chronological order based on respective times and dates that the validation documents have been approved according to respective validation protocols to obtain sorted validation documents; extracts, via the sequence matching-based LLM based on the chronological order, second portions of the respective content from the sorted validation documents to obtain the respected extracted content comprising the attributes of the respective test steps; and populates, via the RAG-based LLM, the empty sections of the document template with the respective extracted content comprising, the attributes of the respective test steps to obtain the validation document.

At 1520, in response to the respective test steps being executed via the defined entity during an execution of the defined validation process, the automated validation content generation system validates, based on the defined validation criteria for the respective test steps represented by the validation document, the execution of the defined validation process.

As it is employed in the subject specification, the terms “processor” and “processing component” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “memory component”, “data store”, “database”, and substantially any other information storage component relevant to operation and functionality of a component and/or process, refer to memory components, or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in memory component 250, non-volatile memory 1622 (see below), disk storage 1624 (see below), and/or memory storage 1646 (see below). Further, nonvolatile memory can be included in read only memory (ROM), programmable ROM (PROM), electrically programmable ROM (EPROM), electrically erasable ROM (EEPROM), or flash memory. Volatile memory 1220 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

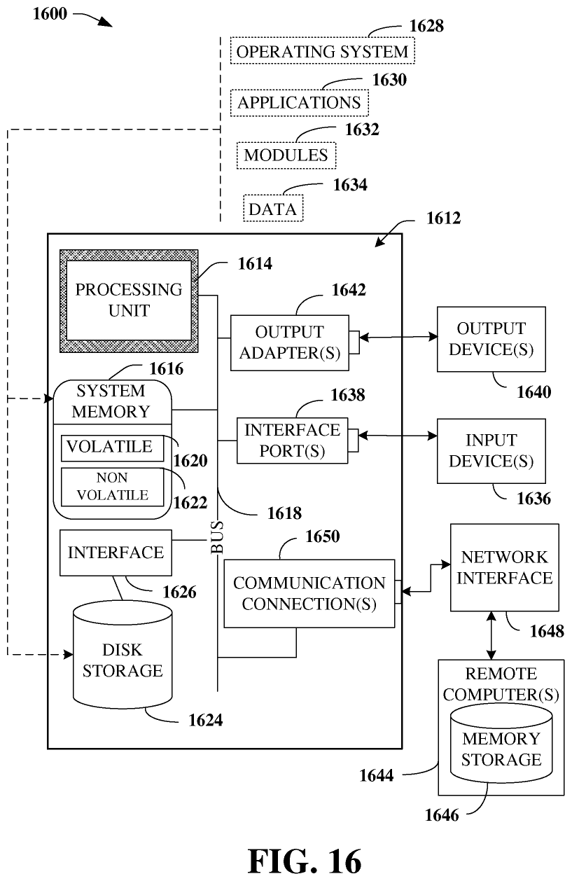

In order to provide a context for the various aspects of the disclosed subject matter, FIG. 16, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 16, a block diagram of a computing system 1600 operable to execute the disclosed systems and methods is illustrated, in accordance with an embodiment. Computer 1612 comprises a processing unit 1614, a system memory 1616, and a system bus 1618. System bus 1618 couples system components comprising, but not limited to, system memory 1616 to processing unit 1614. Processing unit 1614 can be any of various available processors. Dual microprocessors and other multiprocessor architectures can also be employed as processing unit 1614.

System bus 1618 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1616 comprises volatile memory 1620 and nonvolatile memory 1622. A basic input/output system (BIOS), containing routines to transfer information between elements within computer 1612, such as during start-up, can be stored in nonvolatile memory 1622. By way of illustration, and not limitation, nonvolatile memory 1622 can comprise ROM, PROM, EPROM, EEPROM, or flash memory. Volatile memory 1620 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1612 also comprises removable/non-removable, volatile/non-volatile computer storage media. FIG. 16 illustrates, for example, disk storage 1624. Disk storage 1624 comprises, but is not limited to, devices like a magnetic disk drive, floppy disk drive, tape drive, Jaz drive, Zip drive, LS-100 drive, flash memory card, or memory stick. In addition, disk storage 1624 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1624 to system bus 1618, a removable or non-removable interface is typically used, such as interface 1626.

It is to be appreciated that FIG. 16 describes software that acts as an intermediary between users and computer resources described in suitable operating environment 1600. Such software comprises an operating system 1628. Operating system 1628, which can be stored on disk storage 1624, acts to control and allocate resources of computer system 1612. System applications 1630 take advantage of the management of resources by operating system 1628 through program modules 1632 and program data 1634 stored either in system memory 1616 or on disk storage 1624. It is to be appreciated that the disclosed subject matter can be implemented with various operating systems or combinations of operating systems.

A user can enter commands or information into computer 1612 through input device(s) 1636. Input devices 1636 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1614 through system bus 1618 via interface port(s) 1638. Interface port(s) 1638 comprise, for example, a serial port, a parallel port, a game port, a universal serial bus (USB), a wireless based port, e.g., Wi-Fi, Bluetooth, etc. Output device(s) 1640 use some of the same type of ports as input device(s) 1636.

Thus, for example, a USB port can be used to provide input to computer 1612 and to output information from computer 1612 to an output device 1640. Output adapter 1642 is provided to illustrate that there are some output devices 1640, like display devices, light projection devices, monitors, speakers, and printers, among other output devices 1640, which use special adapters. Output adapters 1642 comprise, by way of illustration and not limitation, video and sound devices, cards, etc. that provide means of connection between output device 1640 and system bus 1618. It should be noted that other devices and/or systems of devices provide both input and output capabilities such as remote computer(s) 1644.

Computer 1612 can operate in a networked environment using logical connections to one or more remote computers, such as remote computer(s) 1644. Remote computer(s) 1644 can be a personal computer, a server, a router, a network PC, a workstation, a microprocessor based appliance, a peer device, or other common network node and the like, and typically comprises many or all of the elements described relative to computer 1612.

For purposes of brevity, only a memory storage device 1646 is illustrated with remote computer(s) 1644. Remote computer(s) 1644 is logically connected to computer 1612 through a network interface 1648 and then physically and/or wirelessly connected via communication connection 1650. Network interface 1648 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1650 refer(s) to hardware/software employed to connect network interface 1648 to bus 1618. While communication connection 1650 is shown for illustrative clarity inside computer 1612, it can also be external to computer 1612. The hardware/software for connection to network interface 1648 can comprise, for example, internal and external technologies such as modems, comprising regular telephone grade modems, cable modems and DSL modems, wireless modems, ISDN adapters, and Ethernet cards.

The computer 1612 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1612 can connect to other devices/networks by way of antenna, port, network interface adaptor, wireless access point, modem, and/or the like.

The computer 1612 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Reference throughout this specification to “embodiment(s)”, “one embodiment,” or “an embodiment,” means that a particular feature, structure, or characteristic described in connection with the embodiment is included in at least one embodiment. Thus, the appearances of the phrase “embodiment(s)”, “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, terms “component”, “system”, “interface” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to, random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

In accordance with various embodiments, processor(s) for implementing embodiments disclosed herein can comprise distributed processing devices, or parallel processing devices, in a single machine, device, etc., or across multiple machines, devices, etc. Furthermore, the processor(s) can comprise a state machine, an application specific integrated circuit (ASIC), or a programmable gate array (PGA), e.g., field PGA (FPGA). In this regard, when the processor(s) execute instruction(s) to perform “operations”, the processor(s) can perform the operations directly, and/or facilitate, direct, or cooperate with other device(s) and/or component(s) to perform the operations.

In accordance with various aspects of the subject specification, artificial intelligence based systems, components, etc. (e.g., component(s), process(es), and/or service(s), e.g., corresponding to automated validation content generation system 110, can employ classifier(s) that are explicitly trained, e.g., via a generic training data, as well as implicitly trained, e.g., by receiving historical information, by receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by component(s), process(es), and/or service(s) of the automated validation content generation system, comprising, but not limited to: in response to obtaining a document template representing a defined content type of a validation document that comprises defined validation criteria for respective test steps of a defined validation process for a defined process for a defined entity name of a defined entity, determining, by a system, whether a group of validation documents that have been stored in a data store of the system corresponds to the document template representing the defined content type of the validation document for the defined entity name of the defined entity; and in response to the group of validation documents being determined not to correspond to the defined document template representing the defined content type of the validation document for the defined entity name of the defined entity, assigning, by the system using a sequence matching-based LLM, respective validation document scores to the validation documents representing respective degrees of similarity between the document template and the validation documents to obtained scored validation documents, sorting, by the system according to the respective validation document scores, the scored validation documents to obtain a group of sorted scored validation documents, and based on the respective validation document scores, determining, by the system using the sequence matching-based large LLM, whether the group of sorted scored validation documents comprises respective content comprising at least a portion of the defined validation criteria for the respective test steps of the defined validation process for the defined entity name of the defined entity; and in response to the group of sorted scored validation documents being determined to comprise the respective content comprising the portion of the defined validation criteria for the respective test steps of the defined validation process for the defined entity name of the defined entity, extracting, by the system based on the respective validation document scores using the sequence matching-based LLM, the respective content from the group of sorted scored validation documents, and populating, by the system using a RAG-based LLM, respective vacant sections of the document template corresponding to the test steps with the respective content comprising the portion of the defined validation criteria for the respective test steps of the defined validation process for the defined entity name of the defined entity to obtain the validation document.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of automated test case validation execution system disclosed herein, for example, attributes can be information corresponding to operations performed via the automated test case validation execution system that has been stored via a data store, and the classes can be categories or areas of interest, e.g., corresponding to defined conditions and/or thresholds utilized via the automated test case validation execution system. A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can comprise user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable components that, when executed by the at least one processor, facilitate performance of operations by the system, the operations comprising:
obtaining a document template representing a defined content type of a validation document comprising defined validation criteria for respective test steps of a defined validation process for a defined process for a defined entity name of a defined entity, wherein the document template comprises a group of empty sections corresponding to the respective test steps for the defined validation process for the defined entity; and
in response to a group of validation documents that have been stored in a data store of the system being determined not to correspond to the document template representing the defined content type of the validation document for the defined entity name of the defined entity,
based on respective validation document scores that have been assigned, utilizing a sequence matching-based large language learning model (LLM), to the validation documents that have been sorted according to the respective validation document scores to obtain a group of sorted scored validation documents, extracting, via the sequence matching-based LLM, respective extracted content from at least one scored validation document of the group of sorted scored validation documents that has been determined to comprise at least a portion of the defined validation criteria for the respective test steps to be populated in the group of empty sections, and
populating, via a retrieval-augmented generation (RAG)-based LLM, at least one empty section of the group of empty sections of the document template with the respective extracted content comprising the portion of the defined validation criteria for the respective test steps to obtain a completed section of the validation document for the defined validation process for the defined entity.

2. The system of claim 1, wherein the operations further comprise:
in response to the respective test steps being executed via the defined entity during an execution of the defined validation process, validating, based on the defined validation criteria for the respective test steps represented by the validation document, the execution of the defined validation process.

3. The system of claim 1, wherein the document template comprises at least one of a text document or a Microsoft® Word document, wherein a row of a table of the text document or the Microsoft® Word document represents a test step of the respective test steps, wherein a cell of the row of the table that corresponds to a column of the table comprises the empty section of the group of empty sections of the document template, and wherein the operations further comprise:
in response to determining that the document template is not written in English, translating the document template into English; and
in response to determining that one or more validation documents of the group of validation documents that have been stored in the data store are not written in English, translating the one or more validation documents into English.

4. The system of claim 1, wherein the defined content type comprises:
an operational qualification of the defined entity, an installation qualification of the defined entity, a performance qualification of the defined entity, or a design qualification of the defined entity.

5. The system of claim 1, wherein the defined entity comprises:
an equipment that is used during the test step of the respective test steps, an instrument that is used during the test step, a computer system that is used during the test step, software that is used during the test step, or a facility that is used during the test step.

6. The system of claim 1, wherein the extracting of the respective extracted content from the scored validation document further comprises:
assigning, via the sequence matching-based LLM, the respective validation document scores to the validation documents to obtain scored validation documents;
sorting the scored validation documents in a descending order of the respective validation document scores to obtain the group of sorted scored validation documents; and
based on the descending order of the respective validation document scores, extracting, via the sequence matching-based LLM, the respective extracted content from the group of sorted scored validation documents.

7. The system of claim 6, wherein the assigning of the respective validation document scores to the validation documents further comprises:
determining, via the sequence matching-based LLM, respective entity name scores representing respective amounts of similarity between the defined entity name and respective entity names corresponding to the validation documents,
respective content type scores representing respective amounts of similarity between the defined content type and respective content types of the validation documents,
respective section scores representing respective numbers of section names of the group of empty sections of the document template that correspond to respective groups of sections of the validation documents, and
respective sums of the respective entity name scores, the respective content type scores, and the respective section scores; and
assigning, as the respective validation document scores, the respective sums of the respective entity name scores, the respective content type scores, and the respective section scores to the validation documents to obtain the group of sorted scored validation documents.

8. The system of claim 6, wherein the extracting of the respective extracted content from the scored validation document further comprises:
based on the descending order of the respective validation document scores,
iteratively selecting the scored validation document from the group of sorted scored validation documents,
determining, via the sequence matching-based LLM, whether the scored validation document comprises the portion of the defined validation criteria for the respective test steps, and
in response to determining that the scored validation document comprises the portion of the defined validation criteria for the respective test steps, extracting, via the sequence matching-based LLM, the portion of the defined validation criteria for the respective test steps from the scored validation document to facilitate the empty section of the document template being populated, via the RAG-based LLM, with the portion of the defined validation criteria for the respective test steps to obtain the completed section.

9. The system of claim 8, wherein the scored validation document is a first scored validation document corresponding to a first descending order of the descending order of the respective validation scores, and wherein the operations further comprise:
in response to determining that the first scored validation document does not comprise the portion of the defined validation criteria for the respective test steps, and based on the descending order of the respective validation document scores,
iteratively selecting a second scored validation document from the group of sorted scored validation documents corresponding to a second descending order of the descending order of the respective validation scores that directly proceeds the first descending order,
determining, via the sequence matching-based LLM, whether the second scored validation document comprises the portion of the defined validation criteria for the respective test steps, and
in response to determining that the second scored validation document comprises the portion of the defined validation criteria for the respective test steps, extracting, via the sequence matching-based LLM, the portion of the defined validation criteria for the respective test steps from the second scored validation document to facilitate the empty section of the document template being populated, via the RAG-based LLM, with the portion of the defined validation criteria for the respective test steps to obtain the completed section.

10. The system of claim 9, wherein the operations further comprise:
in response to determining that the group of sorted scored validation documents does not comprise the portion of the defined validation criteria for the respective test steps, and further in response to determining that a reference document has been associated with the document template,
determining, via the sequence matching-based LLM, whether the reference document comprises the portion of the defined validation criteria for the respective test steps, and
in response to determining that the reference document comprises the portion of the defined validation criteria for the respective test steps, extracting, via the sequence matching-based LLM, the portion of the defined validation criteria for the respective test steps from the reference document to facilitate the empty section of the document template being populated, via the RAG-based LLM, with the portion of the defined validation criteria for the respective test steps to obtain the completed section.

11. The system of claim 9, wherein the operations further comprise:
in response to determining that a reference document has been associated with the document template,
determining, via the sequence matching-based LLM, whether the reference document comprises the portion of the defined validation criteria for the respective test steps, and
in response to determining that the reference document comprises the portion of the defined validation criteria for the respective test steps, extracting, via the sequence matching-based LLM, the portion of the defined validation criteria for the respective test steps from the reference document to facilitate the completed section of the document template being populated, via the RAG-based LLM, with the portion of the defined validation criteria for the respective test steps.

12. The system of claim 1, wherein the operations further comprise:
in response to the group of validation documents that have been stored in the data store of the system being determined to correspond to the document template representing the defined content type of the validation document for the defined entity name of the defined entity,
sorting the group of validation documents in descending chronological order of respective times and dates that the validation documents have been approved according to respective defined validation processes to obtain a group of chronologically sorted validation documents, and
based on the descending chronological order, extracting, via the sequence matching-based LLM, respective content from the group of chronologically sorted validation documents to facilitate the empty section of the document template being populated, via the RAG-based LLM, with the portion of the defined validation criteria for the respective test steps to obtain the completed section.

13. The system of claim 12, wherein the portion of the defined validation criteria for the respective test steps is a first portion of defined validation criteria, and wherein the extracting of the respective content from the group of chronologically sorted validation documents comprises:
based on the descending chronological order,
iteratively selecting a sorted validation document from the group of chronologically sorted validation documents,
determining whether the sorted validation document comprises a second portion of the defined validation criteria for the respective test steps, and
in response to determining that the sorted validation document comprises the second portion of the defined validation criteria for the respective test steps, extracting, via the sequence matching-based LLM, the second portion of the defined validation criteria for the respective test steps from the sorted validation document to facilitate the empty section of the document template being populated, via the RAG-based LLM, with the second portion of the defined validation criteria for the respective test steps to obtain the completed section.

14. The system of claim 13, wherein the sorted validation document is a first sorted validation document corresponding to a first chronological order of the chronological order, and wherein the operations further comprise:
in response to determining that the first sorted validation document does not comprises the portion of the respective content,
iteratively selecting a second sorted validation document from the group of chronologically sorted validation documents that corresponds to a second chronological order of the chronological order that directly precedes the first chronological order,
determining whether the second sorted validation document comprises the portion of the respective content, and
in response to determining that the second sorted validation document comprises the portion of the respective content, extracting, via the sequence matching-based LLM, the portion of the respective content from the second sorted validation document to facilitate the empty section of the document template being populated, via the RAG-based LLM, with the portion of the defined validation criteria for the respective test steps to obtain the completed section.

15. The system of claim 14, wherein the operations further comprise:
in response to determining that the portion of the respective portions of the respective content cannot be extracted from the group of chronologically sorted validation documents, and further in response to determining that a reference document has been associated with the document template,
determining, via the sequence matching-based LLM, whether the reference document comprises the portion of the defined validation criteria for the respective test steps, and
in response to determining that the reference document comprises the portion of the defined validation criteria for the respective test steps, extracting, via the sequence matching-based LLM, the portion of the respective content from the reference document to facilitate the empty section of the document template being populated, via the RAG-based LLM, with the portion of the defined validation criteria for the respective test steps to obtain the completed section.

16. A method, comprising:
in response to obtaining a document template representing a defined content type of a validation document that comprises defined validation criteria for respective test steps of a defined validation process for a defined process for a defined entity name of a defined entity, determining, by a system comprising at least one processor, whether a group of validation documents that have been stored in a data store of the system corresponds to the document template representing the defined content type of the validation document for the defined entity name of the defined entity;
in response to the group of validation documents being determined not to correspond to the defined document template representing the defined content type of the validation document for the defined entity name of the defined entity,
assigning, by the system using a sequence matching-based large language learning model (LLM), respective validation document scores to the validation documents representing respective degrees of similarity between the document template and the validation documents to obtained scored validation documents,
sorting, by the system according to the respective validation document scores, the scored validation documents to obtain a group of sorted scored validation documents, and
based on the respective validation document scores, determining, by the system using the sequence matching-based large LLM, whether the group of sorted scored validation documents comprises respective content comprising at least a portion of the defined validation criteria for the respective test steps of the defined validation process for the defined entity name of the defined entity; and
in response to the group of sorted scored validation documents being determined to comprise the respective content comprising the portion of the defined validation criteria for the respective test steps of the defined validation process for the defined entity name of the defined entity,
extracting, by the system based on the respective validation document scores using the sequence matching-based LLM, the respective content from the group of sorted scored validation documents, and
populating, by the system using a retrieval-augmented generation (RAG)-based LLM, respective vacant sections of the document template corresponding to the test steps with the respective content comprising the portion of the defined validation criteria for the respective test steps of the defined validation process for the defined entity name of the defined entity to obtain the validation document.

17. The method of claim 16, further comprising:
in response to the group of validation documents being determined to correspond to the defined document template representing the defined content type of the validation document for the defined entity name of the defined entity,
sorting, by the system, the group of validation documents in chronological order based on respective times and dates that the validation documents have been approved according to respective validation protocols to obtain sorted validation documents,
extracting, by the system based on the chronological order using the sequence matching-based LLM, the respective content from the sorted validation documents, and
populating, by the system using the RAG-based LLM, the respective vacant sections of the document template corresponding to the test steps with the respective content comprising the portion of the defined validation criteria for the respective test steps of the defined validation process for the defined entity name of the defined entity to obtain the validation document.

18. The method of claim 16, wherein the assigning of the respective validation document scores further comprises:
deriving, via the sequence matching-based LLM, respective entity name scores representing first respective amounts of similarity between the defined entity name and respective entity names corresponding to the validation documents;
deriving, via the sequence matching-based LLM, respective content type scores representing second respective amounts of similarity between the defined content type and respective content types of the validation documents;
deriving, via the sequence matching-based LLM, respective section scores representing respective numbers of section names of the group of sections of the document template that correspond to respective groups of sections of the validation documents; and
based on respective sums of the respective entity name scores, the respective content type scores, and the respective section scores,
generating the respective validation document scores, and
assigning the respective validation document scores to the validation documents.

19. A non-transitory machine-readable medium, comprising executable instructions that, when executed by at least one processor of a system, facilitate performance of operations, comprising:
obtaining a document template corresponding to a defined content type representing a type of a validation document, wherein the document template comprises empty sections corresponding to respective test steps of a defined validation process for a defined process for a defined entity name of a defined entity, and wherein respective content that is populated in the empty sections of the document template is utilized during an execution of the respective test steps of the defined validation process;
determining whether validation documents that have been stored in a data store of the system correspond to the document template corresponding to the defined content type representing the type of the validation document and the defined validation process for the defined entity name of the defined entity; and
in response to determining that the validation documents do not correspond to the document template corresponding to the defined content type representing the type of the validation document and the defined validation process for the defined entity name of the defined entity,
extracting, via a sequence matching-based large language learning model (LLM) based on respective validation document scores that have been assigned to the validation documents, portions of the respective content from the validation documents to obtain respective extracted content comprising attributes of the respective test steps, and
populating, via a retrieval-augmented generation (RAG)-based LLM, the empty sections of the document template with the respective extracted content comprising the attributes of the respective test steps to obtain the validation document.

20. The non-transitory machine-readable medium of claim 19, wherein the portions are first portions, and wherein the operations further comprise:
in response to determining that the validation documents correspond to the document template corresponding to the defined content type representing the type of the validation document and the defined validation process for the defined entity name of the defined entity,
sorting the validation documents in chronological order based on respective times and dates that the validation documents have been approved according to respective validation protocols to obtain sorted validation documents,
extracting, via the sequence matching-based LLM based on the chronological order, second portions of the respective content from the sorted validation documents to obtain the respected extracted content comprising the attributes of the respective test steps, and
populating, via the RAG-based LLM, the empty sections of the document template with the respective extracted content comprising the attributes of the respective test steps to obtain the validation document.
